(19) United States
(12) Patent Application Publication
(10) Pub. No.: US 2024/0166294 A1
(43) Pub. Date: May 23, 2024

(54) SHAFT MEMBER FOR HUMAN-POWERED VEHICLE, HUB FOR HUMAN-POWERED VEHICLE, WHEEL AXLE FOR HUMAN-POWERED VEHICLE, AND DETECTION DEVICE FOR HUMAN-POWERED VEHICLE

(71) Applicant: Shimano Inc., Osaka (JP)

(72) Inventors: Kazuya OKUMURA, Osaka (JP); Kazuki KOSHIYAMA, Osaka (JP)

(21) Appl. No.: 18/384,312

(22) Filed: Oct. 26, 2023

(30) Foreign Application Priority Data
Nov. 21, 2022 (JP) 2022-186000

(51) Int. Cl. B62K 25/02; B62J 45/20; B62J 45/41

(52) U.S. Cl. CPC B62K 25/02; B62J 45/20; B62J 45/41

(57) ABSTRACT

A shaft member is provided for a human-powered vehicle. The shaft member is configured to be attachable to a body of the human-powered vehicle in a manner restricting rotation relative to the body. The shaft member includes a setting surface on which a plurality of strain gauges are arrangeable. The setting surface includes a plurality of setting portions configured to allow for arrangement of one or more of the strain gauges. The setting portions are provided in the setting surface at different positions in a circumferential direction of the shaft member.

### CROSS-REFERENCE TO RELATED APPLICATIONS

This application claims priority to Japanese Patent Application No. 2022-186000, filed on Nov. 21, 2022. The entire disclosure of Japanese Patent Application No. 2022-186000 is hereby incorporated herein by reference.

### BACKGROUND

### Technical Field

The present disclosure generally relates to a shaft member for a human-powered vehicle, a hub for a human-powered vehicle, a wheel axle for a human-powered vehicle, and a detection device for a human-powered vehicle.

### Background Information

Canada Patent Application Publication No. 2426109 discloses an example of a human-powered vehicle in which a strain gauge is attached to a wheel axle.

### SUMMARY

One object of the present disclosure is to provide a shaft member for a human-powered vehicle, a wheel axle for a human-powered vehicle, a hub for a human-powered vehicle, and a detection device for a human-powered vehicle that allow for attachment of a strain gauge so that the strain gauge appropriately detects strain.

A shaft member in accordance with a first aspect of the present disclosure is for a human-powered vehicle. The shaft member is configured to be attachable to a body of the human-powered vehicle in a manner restricting rotation relative to the body. The shaft member comprises a setting surface on which strain gauges are arrangeable. The setting surface includes a plurality of setting portions configured to allow for arrangement of one or more of the strain gauges. The setting portions are provided in the setting surface at different positions in a circumferential direction of the shaft member.

With the shaft member according to the first aspect, the setting portions are provided in the setting surface at different positions in the circumferential direction of the shaft member. This allows the strain gauges arranged on each setting portion to detect strain from a different position in the circumferential direction of the shaft member. Thus, the shaft member allows for attachment of the strain gauges so that the strain gauges appropriately detect strain.

In accordance with a second aspect of the present disclosure, the shaft member according to the first aspect is configured so that each of the setting portions includes a flat part.

With the shaft member according to the second aspect, each of the setting portions includes a flat portion. Thus, the shaft member allows for stable attachment of the strain gauges to the setting portions.

In accordance with a third aspect of the present disclosure, the shaft member according to the first or second aspect is configured so that each of the setting portions includes a recess.

With the shaft member according to the third aspect, each of the setting portions includes a recess. This limits projection of the strain gauges from the recess. Thus, the shaft member allows for stable attachment of the strain gauges to the setting portions.

In accordance with a fourth aspect of the present disclosure, in the shaft member according to any one of the first to third aspects, at least one of the setting portions is configured to allow at least two of the strain gauges to be arranged in an axial direction of the shaft member.

With the shaft member according to the fourth aspect, at least one of the setting portions allows at least two of the strain gauges to be arranged in the axial direction of the shaft member. This improves the accuracy of the shaft member for detecting strain.

In accordance with a fifth aspect of the present disclosure, the shaft member according to any one of the first to fifth aspects is configured so that two of the setting portions are provided at positions that differ in phase by 90 degrees in the circumferential direction of the shaft member.

With the shaft member according to the fifth aspect, two of the setting portions are provided at positions that differ in phase by 90 degrees in the circumferential direction of the shaft member. This allows the strain gauges to detect strain at positions that differ in phase by 90 degrees in the circumferential direction of the shaft member.

In accordance with a sixth aspect of the present disclosure, the shaft member according to any one of the first to fifth aspects is configured so that two of the setting portions are provided at positions that differ in phase by 180 degrees in the circumferential direction of the shaft member.

With the shaft member according to the sixth aspect, two of the setting portions are provided at positions that differ in phase by 180 degrees in the circumferential direction of the shaft member. This allows the strain gauges to detect strain at positions that differ in phase by 180 degrees in the circumferential direction of the shaft member.

In accordance with a seventh aspect of the present disclosure, the shaft member according to the sixth aspect is configured so that the two of the setting portions are substantially equal in shape.

With the shaft member according to the seventh aspect, two of the setting portions are substantially equal in shape. Thus, detection results of the strain gauges arranged on the two of the setting portions are readily compared.

In accordance with an eighth aspect of the present disclosure, the shaft member according to any one of the first to fourth aspects is configured so that the setting portions include four setting portions. The four setting portions of the setting surface are provided parallel to a center axis of the shaft member at equal intervals in the circumferential direction of the shaft member. The strain gauges arranged on two of the setting portions that differ in phase by 180 degrees in the circumferential direction of the shaft member are bridge-connected to each other.

With the shaft member according to the eighth aspect, the strain gauges arranged on two of the setting portions that differ in phase by 180 degrees in the circumferential direction of the shaft member are bridge-connected to each other. This increases an output of the strain gauges.

In accordance with a ninth aspect of the present disclosure, the shaft member according to any one of the first to eighth aspects further comprises a first end and a second end in an axial direction of the shaft member. The setting surface includes at least one wire groove in which electric wires connected to the strain gauges are arrangeable. The at least one wire groove is located between at least one of the setting portions and at least one of the first end and the second end.

With the shaft member according to the ninth aspect, the at least one wire groove allows electric wires to be arranged along the shaft member between at least one of the setting portions and at least one of the first end and the second end.

In accordance with a tenth aspect of the present disclosure, the shaft member according to the ninth aspect is configured so that the at least one wire groove is located between every one of the setting portions and at least one of the first end and the second end.

With the shaft member according to the tenth aspect, the at least one wire groove allows electric wires to be arranged along the shaft member between every one of the setting portions and at least one of the first end and the second end.

In accordance with an eleventh aspect of the present disclosure, the shaft member according to the ninth or tenth aspect is configured so that the first end includes a male thread used for attaching the shaft member to the body. The at least one wire groove is located between at least one of the setting portions and the first end. The at least one wire groove extends through the male thread in the setting surface.

With the shaft member according to the eleventh aspect, the at least one wire groove allows electric wires to extend through the male thread along the shaft member between at least one of the setting portions and the first end.

In accordance with a twelfth aspect of the present disclosure, the shaft member according to the eleventh aspect is configured so that the first end has a larger maximum outer diameter than the second end.

With the shaft member according to the twelfth aspect, the at least one wire groove is located between at least one of the setting portions and the first end, which has a larger maximum outer diameter than the second end. This allows the groove to have a greater depth than a case where the groove is located between at least one of the setting portions and the second end.

In accordance with a thirteenth aspect of the present disclosure, the shaft member according to any one of the first to twelfth aspects is configured so that the body includes a frame of the human-powered vehicle. The shaft member is configured to be attachable to the frame.

The shaft member according to the thirteenth aspect is attached to the frame so that rotation of the shaft member relative to the frame is restricted.

In accordance with a fourteenth aspect of the present disclosure, the shaft member according to any one of the first to thirteenth aspects is configured so that the shaft member includes a wheel axle of the human-powered vehicle.

With the shaft member according to the fourteenth aspect, strain of the wheel axle is appropriately detected.

In accordance with a fifteenth aspect of the present disclosure, the shaft member according to any one of the first to thirteenth aspects is configured so that the shaft member includes a hub axle of the human-powered vehicle.

With the shaft member according to the fifteenth aspect, strain of the hub axle is appropriately detected.

In accordance with a sixteenth aspect of the present disclosure, the shaft member according to any one of the first to fifteenth aspects is configured so that the human-powered vehicle includes a hub. The hub includes a hub shell. At least some of the setting portions are arranged in a cavity defined in the hub shell.

With the shaft member according to the sixteenth aspect, the setting portions are arrangeable in the cavity defined in the hub shell. Thus, the hub shell protects the strain gauges.

In accordance with a seventeenth aspect of the present disclosure, the shaft member according to the sixteenth aspect is configured so that the hub shell includes two hub flanges. The setting portions are configured to be arranged between the two hub flanges of the hub shell in an axial direction of the shaft member.

With the shaft member according to the seventeenth aspect, the strain gauges are arrangeable between the two hub flanges of the hub shell in the axial direction of the shaft member.

In accordance with an eighteenth aspect of the present disclosure, the shaft member according to any one of the first to seventeenth aspects further comprises the strain gauges arranged on the setting surface.

With the shaft member according to the eighteenth aspect, the strain gauges appropriately detect strain of the shaft member.

A hub in accordance with a nineteenth aspect of the present disclosure is for a human-powered vehicle. The hub comprises the shaft member according to the fifteenth aspect.

The hub according to the nineteenth aspect allows for attachment of the strain gauges so that the strain gauges appropriately detect strain.

A wheel axle in accordance with a twentieth aspect of the present disclosure is for a human-powered vehicle. The wheel axle comprises a first end in an axial direction of the wheel axle, the first end including a male thread configured to be engaged with a female thread provided in a frame of the human-powered vehicle, and a setting surface including at least one setting portion configured to allow for arrangement of at least one strain gauge.

The wheel axle according to the twentieth aspect allows for attachment of a strain gauge to the male thread engaged with the female thread provided in the frame of the human-powered vehicle so that the strain gauge appropriately detects strain.

In accordance with a twenty-first aspect of the present disclosure, the wheel axle according to the twentieth aspect further comprises a second end opposite the first end in the axial direction of the wheel axle, and at least one of the first end and the second end includes a tool engagement portion engageable with a tool to fasten the male thread to the female thread.

In the wheel axle according to the twenty-first aspect, at least one of the first end and the second end includes a tool engagement portion engageable with a tool to fasten the male thread to the female thread. A strain gauge is attachable to the wheel axle so that the strain gauge appropriately detects strain.

A detection device in accordance with a twenty-second aspect of the present disclosure is for a human-powered vehicle. The detection device comprises at least one strain gauge configured to be provided on a shaft member of the human-powered vehicle, and a calculator that calculates load acting in a lateral direction on the human-powered vehicle in accordance with an output of the at least one strain gauge.

The detection device according to the twenty-second aspect detects load in a lateral direction on the human-powered vehicle in accordance with an output of the at least one strain gauge. Thus, the strain gauge is attached to the shaft member so that the strain gauge appropriately detects strain.

The shaft member for a human-powered vehicle, the wheel axle for a human-powered vehicle, the hub for a human-powered vehicle, and the detection device for a human-powered vehicle according to the present disclosure allow for attachment of a strain gauge so that the strain gauge appropriately detects strain.

### BRIEF DESCRIPTION OF THE DRAWINGS

Referring now to the attached drawings which form a part of this original disclosure.

FIG. 1 is a side elevational view of a human-powered vehicle including a shaft member for a human-powered vehicle, a wheel axle for a human-powered vehicle, a hub for a human-powered vehicle, and a detection device for a human-powered vehicle.

FIG. 2 is a block diagram showing the electrical configuration of the human-powered vehicle including the detection device for the human-powered vehicle shown in FIG. 1.

FIG. 3 is a cross-sectional view of the hub for the human-powered vehicle shown in FIG. 1.

FIG. 4 is a perspective view of the hub for the human-powered vehicle shown in FIG. 2.

FIG. 5 is a perspective view of the shaft member for the human-powered vehicle shown in FIG. 2.

FIG. 6 is a first plan view showing a portion of the shaft member for the human-powered vehicle shown in FIG. 2.

FIG. 7 is a second plan view showing a portion of the shaft member for the human-powered vehicle shown in FIG. 2.

FIG. 8 is a cross-sectional view of the shaft member for the human-powered vehicle taken along section line D8-D8 in FIG. 6.

FIG. 9 is a cross-sectional view of the shaft member for the human-powered vehicle taken along section line D9-D9 in FIG. 6.

### DETAILED DESCRIPTION

Selected embodiments will now be explained with reference to the drawings. It will be apparent to those skilled in the bicycle field from this disclosure that the following descriptions of the embodiments are provided for illustration only and not for the purpose of limiting the invention as defined by the appended claims and their equivalents.

### Embodiment

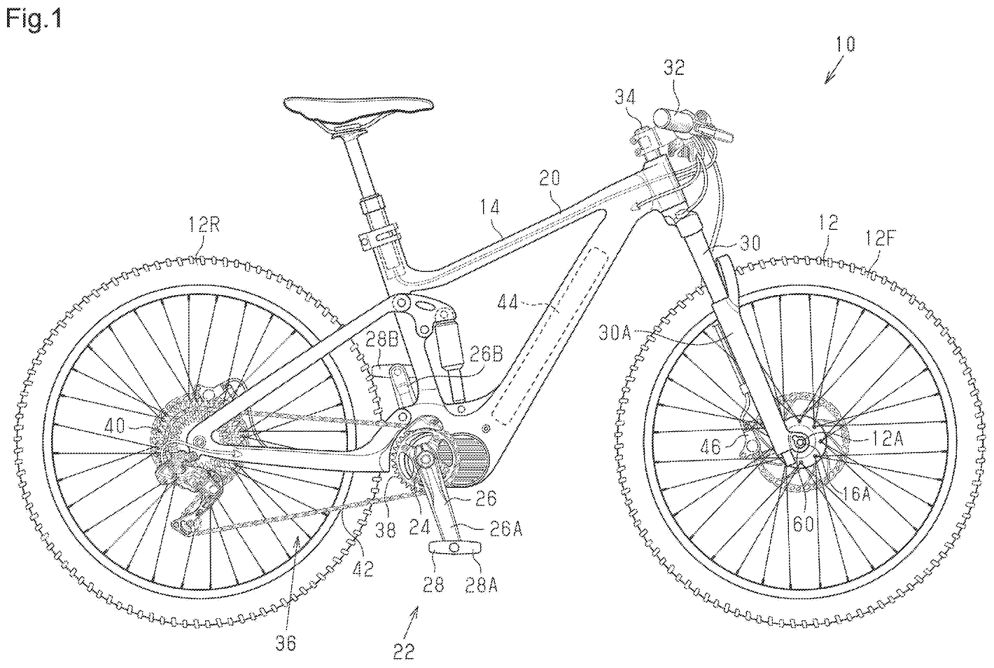

As shown in FIG. 1, a human-powered vehicle 10 is illustrated that is equipped with a wheel 12 having a wheel axle 12A in accordance with one embodiment. A human-powered vehicle is a vehicle including at least one wheel and driven by at least a human driving force. The human-powered vehicle includes, for example, various types of bicycles such as a mountain bike, a road bike, a city bike, a cargo bike, a hand bike, and a recumbent bike. The number of wheels on the human-powered vehicle is not limited. Examples of human-powered vehicles include a unicycle and a vehicle including two or more wheels. The human-powered vehicle is not limited to a vehicle configured to be driven only by a human driving force. The human-powered vehicle includes an E-bike that uses a driving force of an electric motor in addition to human driving force for propulsion. The E-bike includes an electric assist bicycle that assists in propulsion with an electric motor. In the embodiment described below, the human-powered vehicle 10 will be described as a bicycle.

In this specification, the frame of reference for the terms indicating directions such as “front,” “rear,” “frontward,” “rearward,” “left,” “right,” “sideward,” “upward,” and “downward,” as well as other analogous terms indicating directions will be based on the view of a rider who is facing the handlebar from a reference position (e.g., on saddle or seat) of the human-powered vehicle.

As shown in FIG. 1, the human-powered vehicle 10 includes at least one wheel 12 and a body 14. The at least one wheel 12 includes a front wheel 12F and a rear wheel 12R. The at least one wheel 12 includes the wheel axle 12A. The wheel axle 12A is attached to the body 14 of the human-powered vehicle 10 in a manner restricting rotation relative to the body 14. As seen in 3 and 4, the wheel axle 12A is one example of a shaft member 60 in accordance with the present embodiment. In other words, the shaft member 60 includes, for example, the wheel axle 12A for the human-powered vehicle 10.

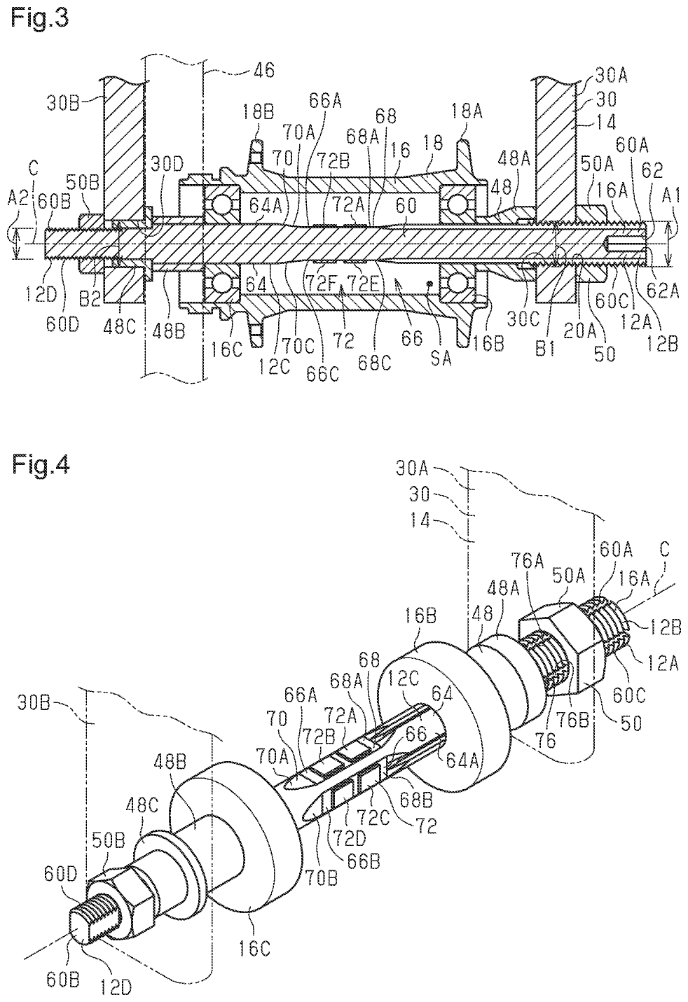

As shown in FIGS. 1 and 3, the human-powered vehicle 10 includes, for example, a hub 16. The hub 16 is provided on the at least one wheel 12. The hub 16 includes at least one of a front hub provided on the front wheel 12F and a rear hub provided on the rear wheel 12R. The hub 16 includes, for example, the shaft member 60. In a case where the human-powered vehicle 10 includes the hub 16, the shaft member 60 includes, for example, a hub axle 16A of the human-powered vehicle 10. In an example, the hub axle 16A is attached to the body 14 in a manner restricting rotation relative to the body 14. In a case where the human-powered vehicle 10 includes the hub 16, the wheel axle 12A includes the hub axle 16A.

The hub 16 includes, for example, a hub shell 18. The hub shell 18 is rotatably provided on the hub axle 16A. The hub shell 18 includes two hub flanges 18A and 18B. Each of the two hub flanges 18A and 18B projects from an outer surface of the hub shell 18 in a radially outward direction of the hub axle 16A. The two hub flanges 18A and 18B are separated from each other in an axial direction of the hub axle 16A. In an example, spokes are attached to the two hub flanges 18A and 18B. The hub shell 18 is configured to rotate integrally with the at least one wheel 12.

The hub 16 further includes, for example, a first bearing 16B and a second bearing 16C. The first bearing 16B and the second bearing 16C support, for example, the hub shell 18 so that the hub shell 18 is rotatable relative to the hub axle 16A. The first bearing 16B and the second bearing 16C are provided, for example, between an inner surface of the hub shell 18 and an outer surface of the hub axle 16A. The first bearing 16B is provided, for example, on one end of the hub shell 18 in the axial direction of the hub axle 16A. The second bearing 16C is provided, for example, on the other end of the hub shell 18 in the axial direction of the hub axle 16A. The first bearing 16B can be, for example, a ball bearing, a roller bearing, or a plain bearing. The second bearing 16C can be, for example, a ball bearing, a roller bearing, or a plain bearing.

The body 14 includes a frame 20 of the human-powered vehicle 10. In an example, a saddle is coupled to the frame 20. The frame 20 includes a front fork 30. The front fork 30 is joined to the frame 20. The front wheel 12F is attached to the front fork 30. A handlebar 32 is coupled to the front fork 30 by a stem 34. The rear wheel 12R is supported by the frame 20. In a case where the hub 16 includes a rear hub, the hub axle 16A is attached to, for example, a rear end of the frame 20. In a case where the hub 16 includes a front hub, the hub axle 16A is coupled to, for example, the front fork 30.

The human-powered vehicle 10 further includes, for example, a crank 22 into which human driving force is input. The crank 22 includes, for example, a crank axle 24 and a crank arm 26. The crank axle 24 is, for example, rotatable relative to the frame 20. In an example, a pedal 28 is coupled to the crank arm 26. The crank arm 26 includes, for example, a first crank arm 26A and a second crank arm 26B. The pedal 28 includes, for example, a first pedal 28A and a second pedal 28B. Each of the first crank arm 26A and the second crank arm 26B is provided, for example, on an axial end of the crank axle 24. The first pedal 28A is coupled to the first crank arm 26A. In an example, the second pedal 28B is coupled to the second crank arm 26B.

In the present embodiment, the crank 22 is coupled to the rear wheel 12R by a drive mechanism 36. The rear wheel 12R is driven, for example, in accordance with rotation of the crank axle 24. Any one of the front wheel 12F and the rear wheel 12R can be coupled to the crank 22 by the drive mechanism 36.

The drive mechanism 36 includes a first rotational body 38 coupled to the crank axle 24. In an example, the first rotational body 38 includes a front sprocket. The first rotational body 38 can include a pulley or a bevel gear. The crank axle 24 can be coupled to the front sprocket by a one-way clutch.

The drive mechanism 36 further includes a second rotational body 40 and a transmission member 42. The transmission member 42 is configured to transmit rotational force of the first rotational body 38 to the second rotational body 40. The transmission member 42 includes, for example, a chain. The transmission member 42 can include a belt or a shaft. The second rotational body 40 includes, for example, a rear sprocket. The second rotational body 40 can include a pulley or a bevel gear. In an example, the chain runs on the front sprocket and the rear sprocket. The second rotational body 40 is, for example, coupled to the rear wheel 12R. The rear wheel 12R is, for example, configured to rotate in accordance with rotation of the second rotational body 40.

The human-powered vehicle 10 further includes, for example, a battery 44. The battery 44 includes, for example, one or more battery elements. The battery element includes, for example, a rechargeable battery. The battery 44 is, for example, configured to supply electric power to a calculator 82. The battery 44 is, for example, connected to the calculator 82 through wired or wireless communication. In an example, the battery 44 is configured to communicate with the calculator 82 through power line communication (PLC). The battery 44 can be configured to communicate with the calculator 82 through controller area network (CAN) or universal asynchronous receiver/transmitter (UART).

The human-powered vehicle 10 further includes, for example, a brake device 46. The brake device 46 is provided, for example, on at least one of the frame 20 and the front fork 30. The brake device 46 is, for example, configured to apply braking force to the at least one wheel 12. The brake device 46 can be a disc brake, a rim brake, or a roller brake.

As shown in FIGS. 3 and 4, the shaft member 60 for a human-powered vehicle is configured to be attachable to the body 14 of the human-powered vehicle 10 in a manner restricting rotation relative to the body 14. In a case where the shaft member 60 is included in a front hub, the shaft member 60 is attached to the front fork 30. FIGS. 3 and 4 show the front hub and the shaft member 60 included in the front hub. A rear hub and the shaft member 60 included in the rear hub can have the same structure as those shown in FIGS. 3 and 4. The shaft member 60 can be configured to be attached to the frame 20 shown in FIG. 1. In a case where the shaft member 60 is included in a rear hub, the shaft member 60 is, for example, attached to the rear end of the frame 20. In a case where the shaft member 60 is included in a rear hub, the following description can be read by replacing the front wheel 12F with the rear wheel 12R and the front fork 30 with the rear end of the frame 20.

As shown in FIGS. 3 to 5, the shaft member 60 includes a setting surface 64 on which a plurality of strain gauges 72 are arrangeable. The shaft member 60 is, for example, cylindrical. The shaft member 60 can be tubular and hollow. The shaft member 60 further includes, for example, a first end 60A and a second end 60B in an axial direction of the shaft member 60. The second end 60B is, for example, an end opposite the first end 60A in the axial direction of the shaft member 60. The wheel axle 12A includes a first end 12B in an axial direction of the wheel axle 12A and a setting surface 12C. The wheel axle 12A further includes a second end 12D opposite the first end 12B in the axial direction of the wheel axle 12A. In the present embodiment, the first end 12B of the wheel axle 12A corresponds to the first end 60A of the shaft member 60. The second end 12D of the wheel axle 12A corresponds to the second end 60B of the shaft member 60. The setting surface 12C of the wheel axle 12A corresponds to the setting surface 64 of the shaft member 60.

The first end 60A includes, for example, a male thread 60C for attaching the shaft member 60 to the body 14. The first end 60A includes, for example, the male thread 60C. The male thread 60C, for example, engages with a female thread 20A provided in the frame 20 of the human-powered vehicle 10. In a case where the front wheel 12F is coupled to the front fork 30 by the shaft member 60, the female thread 20A is provided, for example, in the front fork 30. The second end 60B includes, for example, a male thread 60D.

In an example, a maximum outer diameter A1 of the first end 60A is larger than a maximum outer diameter A2 of the second end 60B. The front fork 30 includes, for example, a first blade 30A and a second blade 30B. The first blade 30A supports, for example, the first end 60A of the shaft member 60. The second blade 30B supports, for example, the second end 60B of the shaft member 60. The first blade 30A is, for example, located at the right side of the hub shell 18 in the axial direction of the shaft member 60. The second blade 30B is, for example, located at the left side of the hub shell 18 in the axial direction of the shaft member 60. The first blade 30A includes, for example, a first hole 30C for attaching the shaft member 60. The first hole 30C includes, for example, the female thread 20A. The second blade 30B includes, for example, a second hole 30D for attaching the shaft member 60. In an example, a maximum inner diameter B1 of the first hole 30C and a maximum inner diameter B2 of the second hole 30D are substantially equal to the maximum outer diameter A1 of the first end 60A. The maximum inner diameter B1 of the first hole 30C and the maximum inner diameter B2 of the second hole 30D are larger than the maximum outer diameter A2 of the second end 60B.

The first bearing 16B and the second bearing 16C of the hub 16 are, for example, separated from each other in the axial direction of the shaft member 60. The first bearing 16B is, for example, located closer to the first blade 30A than the second bearing 16C is in the axial direction of the shaft member 60. The second bearing 16C is, for example, located closer to the second blade 30B than the first bearing 16B is in the axial direction of the shaft member 60. In an example, at least a portion of the brake device 46 is provided between the second bearing 16C and the second blade 30B.

The human-powered vehicle 10 further includes, for example, at least one positioning member 48 that determines the position of the hub 16 with respect to the front fork 30 in the axial direction of the shaft member 60. The at least one positioning member 48 includes, for example, a first positioning member 48A, a second positioning member 48B, and a third positioning member 48C. The first positioning member 48A is provided, for example, between the first bearing 16B and the first blade 30A in the axial direction of the shaft member 60. The second positioning member 48B is provided, for example, between the second bearing 16C and the third positioning member 48C in the axial direction of the shaft member 60. The third positioning member 48C is provided, for example, between the second positioning member 48B and the second blade 30B in the axial direction of the shaft member 60. The first positioning member 48A, the second positioning member 48B, and the third positioning member 48C restrict, for example, movement of the hub 16 in the axial direction of the shaft member 60. The first positioning member 48A, the second positioning member 48B, and the third positioning member 48C include, for example, at least one of a sleeve and a washer.

In an example, the shaft member 60 is configured to be inserted from the second end 60B of the shaft member 60 into the hub 16, the first hole 30C, and the second hole 30D in a state aligned with each other so that the front wheel 12F is coupled to the front fork 30. The shaft member 60 is coupled to the front fork 30 by an engagement member 50. The engagement member 50 includes, for example, a first engagement member 50A and a second engagement member 50B. In a case where the front wheel 12F is coupled to the front fork 30 by the shaft member 60, the first end 60A and the first blade 30A are coupled by the first engagement member 50A. The male thread 60C of the first end 60A, for example, engages with the female thread 20A of the front fork 30 and the first engagement member 50A. In a case where the front wheel 12F is coupled to the front fork 30 by the shaft member 60, the second end 60B and the second blade 30B are coupled by the second engagement member 50B. The male thread 60D of the second end 60B, for example, engages with the second engagement member 50B. The first engagement member 50A and the second engagement member 50B include, for example, a nut.

At least one of the first end 60A and the second end 60B includes, for example, a tool engagement portion 62 engageable with a tool to fasten the male thread 60C to the female thread 20A. The tool engagement portion 62 can have any shape that is engageable with a tool for fastening the male thread 60C to the female thread 20A. In the present embodiment, the tool engagement portion 62 is provided on the first end 60A and includes a recess 62A engageable with the tool. The recess 62A is, for example, configured to engage with a tool such as an Allen key. In an example, a user can detach a wheel 12 from the body 14 by removing the shaft member 60 from the hub shell 18 and the body 14.

The first end 60A can be coupled to the first blade 30A by a lock ring. The first end 60A can be coupled to the first blade 30A by a coupling lever. The coupling lever is, for example, configured to fasten the first end 60A to the first blade 30A by friction.

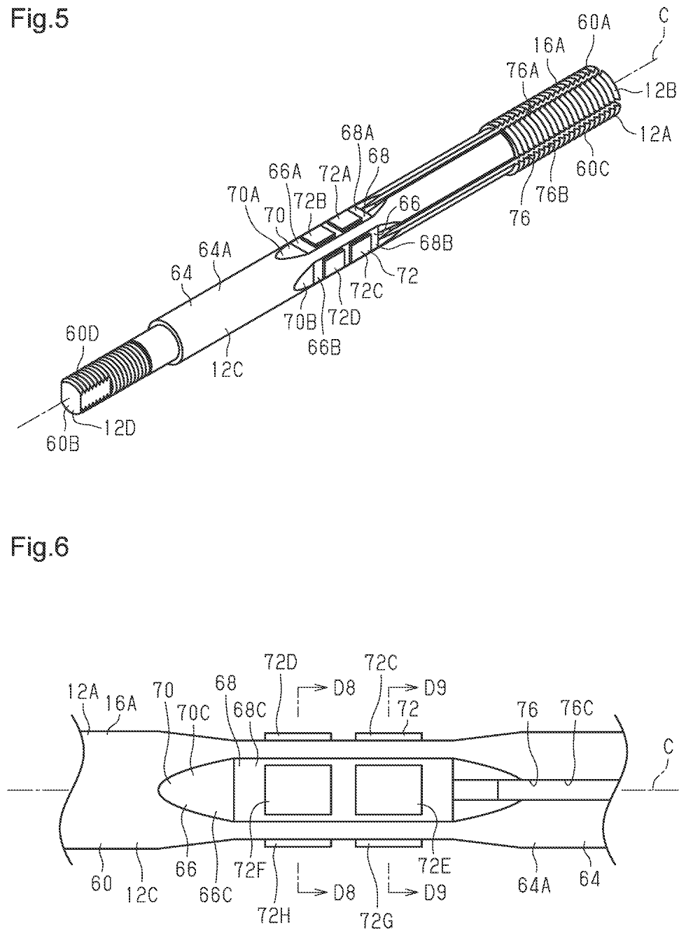

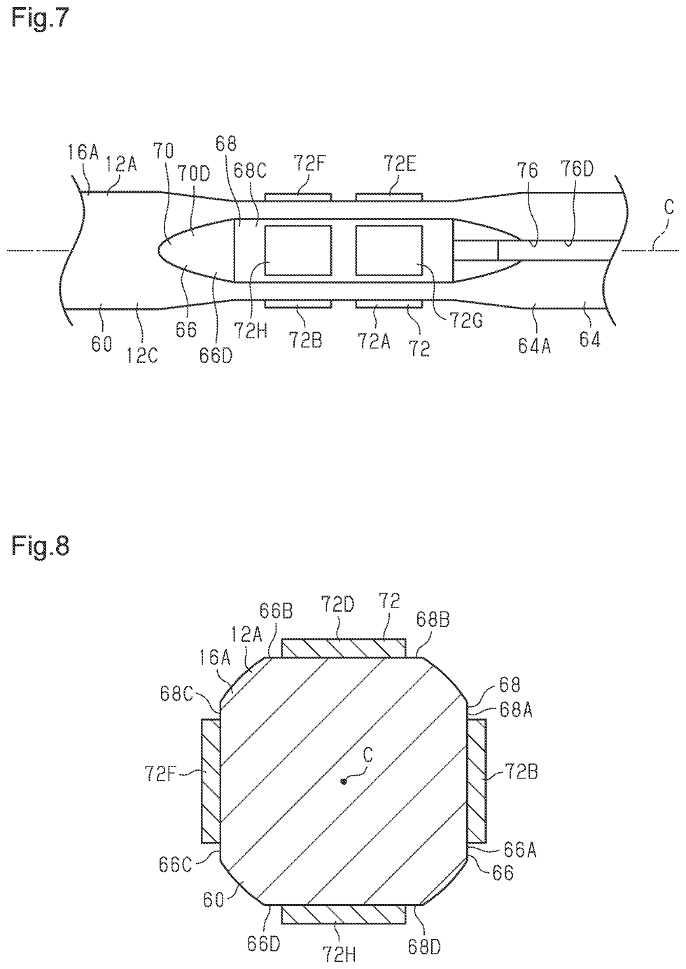

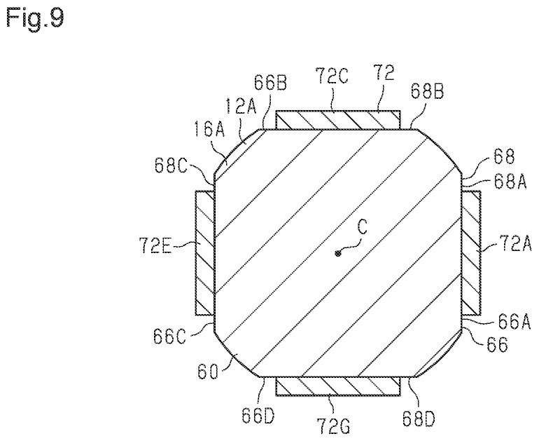

As shown in FIGS. 5 to 9, the setting surface 64 includes, for example, at least one of an outer circumferential surface 64A of the shaft member 60 and an inner circumferential surface of the shaft member 60. In an example, in a case where the shaft member 60 is tubular and hollow, the setting surface 64 includes the inner circumferential surface of the shaft member 60. In the present embodiment, the shaft member 60 is cylindrical, and the setting surface 64 includes the outer circumferential surface 64A of the shaft member 60. The strain gauges 72 are, for example, attached to the outer circumferential surface 64A of the shaft member 60. In a case where the shaft member 60 is tubular and hollow, the setting surface 64 can include an inner circumferential surface of the shaft member 60, and the strain gauges 72 can be attached to the inner circumferential surface of the shaft member 60.

The setting surface 64 includes, for example, at least one setting portion 66. The at least one setting portion 66 includes, for example, setting portions 66. The setting surface 64 includes the setting portions 66. In a case where the setting surface 64 includes the outer circumferential surface 64A of the shaft member 60, the outer circumferential surface 64A includes, for example, the setting portions 66. The setting portions 66 are provided in the setting surface 64 at different positions in a circumferential direction of the shaft member 60. Two of the setting portions 66 are provided at positions that differ in phase by 90 degrees in the circumferential direction of the shaft member 60. Two of the setting portions 66 are provided at positions that differ in phase by 180 degrees in the circumferential direction of the shaft member 60. The two of the setting portions 66 are substantially equal in shape.

The setting portions 66 include, for example, four setting portions 66. The four setting portions 66 of the setting surface 64 are, for example, provided parallel to a center axis C of the shaft member 60 at equal intervals in the circumferential direction of the shaft member 60. The four setting portions 66 include a first setting portion 66A, a second setting portion 66B, a third setting portion 66C, and a fourth setting portion 66D. The first setting portion 66A and the second setting portion 66B are provided, for example, at positions that differ in phase by 90 degrees in the circumferential direction of the shaft member 60. The second setting portion 66B and the third setting portion 66C are provided, for example, at positions that differ in phase by 90 degrees in the circumferential direction of the shaft member 60. The third setting portion 66C and the fourth setting portion 66D are provided, for example, at positions that differ in phase by 90 degrees in the circumferential direction of the shaft member 60. The fourth setting portion 66D and the first setting portion 66A are provided, for example, at positions that differ in phase by 90 degrees in the circumferential direction of the shaft member 60. The first setting portion 66A and the third setting portion 66C are provided, for example, at positions that differ in phase by 180 in the circumferential direction of the shaft member 60. The second setting portion 66B and the fourth setting portion 66D are provided, for example, at positions that differ in phase by 180 in the circumferential direction of the shaft member 60.

Each of the setting portions 66 includes, for example, a flat part 68. The strain gauges 72 are, for example, adhered to the flat parts 68. Each of the setting portions 66 includes, for example, a recess 70. In the present embodiment, the flat part 68 is provided on the bottom of the recess 70. The first setting portion 66A includes, for example, a first flat part 68A and a first recess 70A. The second setting portion 66B includes, for example, a second flat part 68B and a second recess 70B. The third setting portion 66C includes, for example, a third flat part 68C and a third recess 70C. The fourth setting portion 66D includes, for example, a fourth flat part 68D and a fourth recess 70D.

As shown in FIG. 3, at least some of the setting portions 66 are arranged, for example, in a cavity SA defined in the hub shell 18. The setting portions 66 are, for example, configured to be arranged between the two hub flanges 18A and 18B of the hub shell 18 in the axial direction of the shaft member 60. The flat parts 68 and the recesses 70 are, for example, arranged in the cavity SA. The flat parts 68 and the recesses 70 are, for example, arranged between the two hub flanges 18A and 18B of the hub shell 18 in the axial direction of the shaft member 60.

As shown in FIGS. 5 to 9, the shaft member 60 further includes, for example, the strain gauges 72. The strain gauges 72 are configured to detect strain of the shaft member 60. The strain gauges 72 are sheet-shaped. The strain gauges 72 are connected to the calculator 82 by electrical wires 74. The strain gauges 72 include, for example, a first strain gauge 72A, a second strain gauge 72B, a third strain gauge 72C, a fourth strain gauge 72D, a fifth strain gauge 72E, a sixth strain gauge 72F, a seventh strain gauge 72G, and an eighth strain gauge 72H. The electrical wires 74 include, for example, a first electrical wire 74A, a second electrical wire 74B, a third electrical wire 74C, a fourth electrical wire 74D, a fifth electrical wire 74E, a sixth electrical wire 74F, a seventh electrical wire 74G, and an eighth electrical wire 74H.

The first strain gauge 72A is, for example, connected to the calculator 82 by the first electrical wire 74A. The second strain gauge 72B is, for example, connected to the calculator 82 by the second electrical wire 74B. The third strain gauge 72C is, for example, connected to the calculator 82 by the third electrical wire 74C. The fourth strain gauge 72D is, for example, connected to the calculator 82 by the fourth electrical wire 74D. The fifth strain gauge 72E is, for example, connected to the calculator 82 by the fifth electrical wire 74E. The sixth strain gauge 72F is, for example, connected to the calculator 82 by the sixth electrical wire 74F. The seventh strain gauge 72G is, for example, connected to the calculator 82 by the seventh electrical wire 74G. The eighth strain gauge 72H is, for example, connected to the calculator 82 by the eighth electrical wire 74H.

The at least one setting portion 66 is, for example, configured to allow for arrangement of at least one strain gauge 72. The setting portions 66 are configured to allow for arrangement of one or more of the strain gauges 72. At least one of the setting portions 66 is, for example, configured to allow at least two of the strain gauges 72 to be arranged in the axial direction of the shaft member 60.

The first strain gauge 72A and the second strain gauge 72B are, for example, arranged on the first flat part 68A of the first setting portion 66A in the axial direction of the shaft member 60. The first strain gauge 72A is, for example, located on a position of the first flat part 68A closer to the first end 60A than the second strain gauge 72B is. The second strain gauge 72B is, for example, located on a position of the first flat part 68A closer to the second end 60B than the first strain gauge 72A is. The third strain gauge 72C and the fourth strain gauge 72D are, for example, arranged on the second flat part 68B of the second setting portion 66B in the axial direction of the shaft member 60. The third strain gauge 72C is, for example, located on a position of the second flat part 68B closer to the first end 60A than the fourth strain gauge 72D is. The fourth strain gauge 72D is, for example, located on a position of the second flat part 68B closer to the second end 60B than the third strain gauge 72C is.

The fifth strain gauge 72E and the sixth strain gauge 72F are, for example, arranged on the third flat part 68C of the third setting portion 66C in the axial direction of the shaft member 60. The fifth strain gauge 72E is, for example, located on a position of the third flat part 68C closer to the first end 60A than the sixth strain gauge 72F. The sixth strain gauge 72F is, for example, located on a position of the third flat part 68C closer to the second end 60B than the fifth strain gauge 72E is. The seventh strain gauge 72G and the eighth strain gauge 72H are, for example, arranged on the fourth flat part 68D of the fourth setting portion 66D in the axial direction of the shaft member 60. The seventh strain gauge 72G is, for example, located on a position of the fourth flat part 68D closer to the first end 60A than the eighth strain gauge 72H is. The eighth strain gauge 72H is, for example, located on a position of the fourth flat part 68D closer to the second end 60B than the seventh strain gauge 72G is.

The strain gauges 72 arranged on two of the setting portions 66 that differ in phase by 180 degrees in the circumferential direction of the shaft member 60 are bridge-connected to each other. The first strain gauge 72A and the fifth strain gauge 72E are, for example, bridge-connected to each other. The second strain gauge 72B and the sixth strain gauge 72F are, for example, bridge-connected to each other. The third strain gauge 72C and the seventh strain gauge 72G are, for example, bridge-connected to each other. The fourth strain gauge 72D and the eighth strain gauge 72H are, for example, bridge-connected to each other.

The setting surface 64 includes, for example, at least one wire groove 76 in which the electrical wires 74 connected to the strain gauges 72 are arrangeable. The at least one wire groove 76 is, for example, located between at least one of the setting portions 66 and at least one of the first end 60A and the second end 60B. The at least one wire groove 76 is located between every one of the setting portions 66 and at least one of the first end 60A and the second end 60B. The at least one wire groove 76 is located between at least one of the setting portions 66 and the first end 60A and extends through the male thread 60C in the setting surface 64.

The at least one wire groove 76 includes, for example, wire grooves 76. The wire grooves 76 include, for example, a first wire groove 76A, a second wire groove 76B, a third wire groove 76C, and a fourth wire groove 76D. The first wire groove 76A is, for example, located between the first setting portion 66A and the first end 60A and extends through the male thread 60C in the setting surface 64. The second wire groove 76B is, for example, located between the second setting portion 66B and the first end 60A and extends through the male thread 60C in the setting surface 64. The third wire groove 76C is, for example, located between the third setting portion 66C and the first end 60A and extends through the male thread 60C in the setting surface 64. The fourth wire groove 76D is, for example, located between the fourth setting portion 66D and the first end 60A and extends through the male thread 60C in the setting surface 64.

For example, the first electrical wire 74A and the second electrical wire 74B are arranged in the first wire groove 76A. For example, the third electrical wire 74C and the fourth electrical wire 74D are arranged in the second wire groove 76B. For example, the fifth electrical wire 74E and the sixth electrical wire 74F are arranged in the third wire groove 76C. For example, the seventh electrical wire 74G and the eighth electrical wire 74H are arranged in the fourth wire groove 76D.

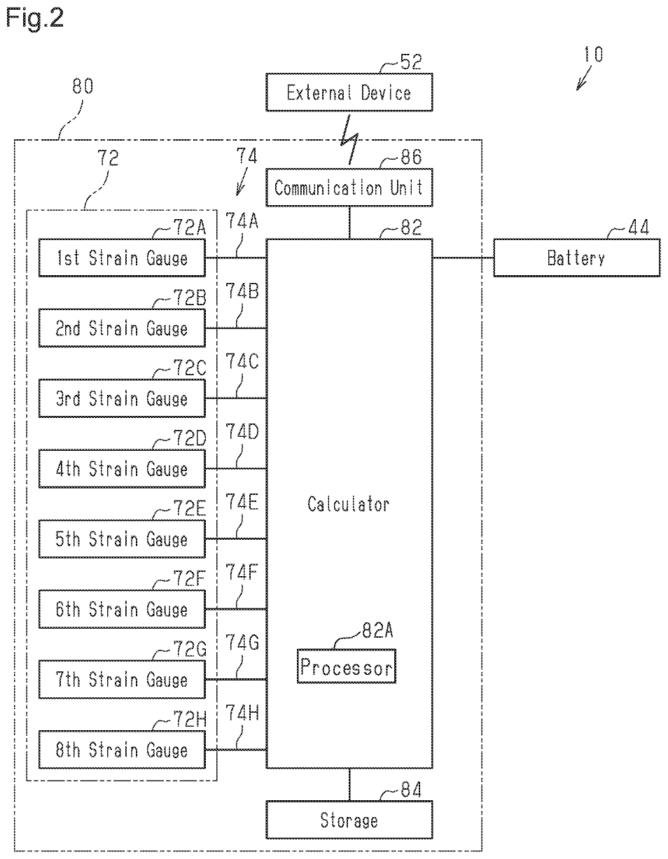

As shown in FIG. 2, for example, the human-powered vehicle 10 includes a detection device 80 for a human-powered vehicle. The detection device 80 is provided, for example, on the hub 16. A portion of the detection device 80 can be provided on the body 14 or a human-powered vehicle component mounted on the body 14. The detection device 80 for a human-powered vehicle includes the at least one strain gauge 72 provided on the shaft member 60 of the human-powered vehicle 10 and the calculator 82.

The calculator 82 is formed of one or more semiconductor chips that are mounted on a circuit board. The calculator 82 can also be referred to as an electronic controller. Thus, the terms “electronic controller” and “calculator” as used herein refer to hardware that executes a software program, and does not include a human being. The calculator 82 includes, for example, one or more processors 82A that executes a predetermined control program. The processor includes, for example, a central processing unit (CPU) or a micro processing unit (MPU). The calculator 82 can include one or more microcomputers. The calculator 82 can include the processors 82A arranged at separate locations. At least a part of the detection device 80 other than the strain gauges 72 can be provided on an external device 52. The external device 52 includes, for example, at least one of a personal computer, a tablet computer, a smartphone, and a cycle computer.

The detection device 80 further includes, for example, storage 84. The storage 84 stores, for example, control programs and information used for various control processes. The storage 84 stores, for example, a program related to the detection device 80 for a human-powered vehicle. The storage 84 includes, for example, at least one of a nonvolatile memory and a volatile memory. The nonvolatile memory includes, for example, at least one of a read-only memory (ROM), an erasable programmable read only memory (EPROM), an electrically erasable programmable read-only memory (EEPROM), and a flash memory. The volatile memory includes, for example, a random access memory (RAM). The storage 84 is, for example, configured to perform wired or wireless communication with the calculator 82. The storage 84 is any computer storage device or any non-transitory computer-readable medium with the sole exception of a transitory, propagating signal.

The detection device 80 further includes, for example, a communication unit 86. The term “communication unit” as used herein refers to a device or devices, and does not include a human being. The communication unit 86 can also be referred to as a communicator. The communication unit 86 is, for example, configured to perform wired or wireless communication with the external device 52. The communication unit 86 is, for example, configured to perform wired or wireless communication with the calculator 82. The communication unit 86 is configured to transmit a signal related to strain of the human-powered vehicle 10 detected by the at least one strain gauge 72 to the external device 52. The detection device 80 can include an amplifier that is electrically connected to the strain gauges 72 and amplify signals output from the strain gauges 72.

The calculator 82 is, for example, configured to calculate load on the human-powered vehicle 10 in accordance with an output of at least one strain gauge 72. In a case where the shaft member 60 is coupled to the front fork 30, the output of the at least one strain gauge 72 corresponds to load received by the front wheel 12F. The load received by the front wheel 12F is transmitted to the shaft member 60 through, for example, the hub shell 18, the first bearing 16B, and the second bearing 16C. The load applied to the front wheel 12F strains the shaft member 60. This changes the electrical resistance value output by the at least one strain gauge 72 provided on the shaft member 60.

Force acting from the front fork 30 toward the shaft member 60 strains the shaft member 60 so that the first end 60A and the second end 60B of the shaft member 60 are forced downward. Thus, at least one strain gauge 72 arranged on a surface of the shaft member 60 facing upward detects a tensile strain in the axial direction of the shaft member 60. At least one strain gauge 72 arranged on a surface of the shaft member 60 facing downward detects a compression strain in the axial direction of the shaft member 60. Force acting from the shaft member 60 toward the front fork 30 or force of the rider lifting the front fork 30 strains the shaft member 60 so that the first end 60A and the second end 60B of the shaft member 60 are forced upward. Thus, at least one strain gauge 72 arranged on a surface of the shaft member 60 facing upward detects a compression strain in the axial direction of the shaft member 60. At least one strain gauge 72 arranged on a surface of the shaft member 60 facing downward detects a tensile strain in the axial direction of the shaft member 60.

In an example, the first strain gauge 72A and the second strain gauge 72B are arranged on a surface of the shaft member 60 facing upward, and the fifth strain gauge 72E and the sixth strain gauge 72F are arranged on a surface of the shaft member 60 facing downward. The first strain gauge 72A and the second strain gauge 72B can be arranged on a surface of the shaft member 60 facing upward in a direction in which the front fork 30 extends, and the fifth strain gauge 72E and the sixth strain gauge 72F can be arranged on a surface of the shaft member 60 facing downward in a direction in which the front fork 30 extends.

In a case where the shaft member 60 strains so that the first end 60A and the second end 60B of the shaft member 60 are forced downward, the tensile strain detected by the first strain gauge 72A and the second strain gauge 72B is increased, and the compression strain detected by the fifth strain gauge 72E and the sixth strain gauge 72F is increased. In a case where the shaft member 60 strains so that the first end 60A and the second end 60B of the shaft member 60 are forced upward, the compression strain detected by the first strain gauge 72A and the second strain gauge 72B is increased, and the tensile strain detected by the fifth strain gauge 72E and the sixth strain gauge 72F is increased.

The calculator 82 is, for example, configured to calculate the load acting on the shaft member 60 from the amount of change in electrical resistance value. In an example, the calculator 82 calculates load by performing a multiple regression analysis that uses parameters output from the strain gauges 72 as variables. The parameters output from the strain gauges 72 include, for example, at least two of an output value of the first strain gauge 72A, an output value of the second strain gauge 72B, an output value of the third strain gauge 72C, an output value of the fourth strain gauge 72D, an output value of the fifth strain gauge 72E, an output value of the sixth strain gauge 72F, an output value of the seventh strain gauge 72G, and an output value of the eighth strain gauge 72H.

The load on the human-powered vehicle 10 includes, for example, at least one of load acting in a vertical direction on the human-powered vehicle 10, load acting in a front-rear direction on the human-powered vehicle 10, and load acting in a lateral direction on the human-powered vehicle 10. In an example, the calculator 82 calculates at least one of load acting in a vertical direction on the human-powered vehicle 10, load acting in a front-rear direction on the human-powered vehicle 10, and load acting in a lateral direction on the human-powered vehicle 10 in accordance with an output of at least one strain gauge 72. In an example, the calculator 82 calculates load acting in a vertical direction in accordance with a strain of the shaft member 60 generated by reaction force of the road on which the human-powered vehicle 10 is traveling on the front wheel 12F at the point of contact of the road with the front wheel 12F.

In an example, the calculator 82 calculates the load acting in a vertical direction on the human-powered vehicle 10 using Expression 1. In Expression 1, the term “F1” represents load acting in a vertical direction on the human-powered vehicle 10. In Expression 1, the term “e1” represents an output value of the first strain gauge 72A. In Expression 1, the term “e2” represents an output value of the second strain gauge 72B. In Expression 1, the term “e5” represents an output value of the fifth strain gauge 72E. In Expression 1, the term “e6” represents an output value of the sixth strain gauge 72F. In Expression 1, the term “a1” represents a calibration factor for converting a detection value of the first strain gauge 72A into a load. In Expression 1, the term “a2” represents a calibration factor for converting a detection value of the second strain gauge 72B into a load. In Expression 1, the term “a5” represents a calibration factor for converting a detection value of the fifth strain gauge 72E into a load. In Expression 1, the term “a6” represents a calibration factor for converting a detection value of the sixth strain gauge 72F into a load.

F1=a1×e1+a2×e2+a5×e5+a6×e6 Expression 1:

In an example, the calculator 82 calculates load acting in a front-rear direction on the human-powered vehicle 10 in accordance with an output of at least one strain gauge 72. In an example, the calculator 82 calculates load acting in a front-rear direction in accordance with a strain of the shaft member 60 generated by reaction force of an object present on the road on which the human-powered vehicle 10 is traveling on the front wheel 12F at the point of contact of the object with the front wheel 12F.

In an example, the calculator 82 calculates the load acting in the front-rear direction on the human-powered vehicle 10 using Expression 2. In Expression 2, the term “F2” represents load acting in a front-rear direction on the human-powered vehicle 10. In Expression 2, the term “e3” represents an output value of the third strain gauge 72C. In Expression 2, the term “e4” represents an output value of the fourth strain gauge 72D. In Expression 2, the term “e7” represents an output value of the seventh strain gauge 72G. In Expression 2, the term “e8” represents an output value of the eighth strain gauge 72H. In Expression 2, the term “a3” represents a calibration factor for converting a detection value of the third strain gauge 72C into a load. In Expression 2, the term “a4” represents a calibration factor for converting a detection value of the fourth strain gauge 72D into a load. In Expression 2, the term “a7” represents a calibration factor for converting a detection value of the seventh strain gauge 72G into a load. In Expression 2, the term “a8” represents a calibration factor for converting a detection value of the eighth strain gauge 72H into a load.

F2=a3×e3+a4×e4+a7×e7+a8×e8 Expression 2:

The calculator 82 calculates load acting in a lateral direction on the human-powered vehicle 10 in accordance with an output of at least one strain gauge 72. The load acting in a lateral direction on the human-powered vehicle 10 relates to, for example, moment about a forward direction of the human-powered vehicle 10. In an example, the calculator 82 calculates the load acting in a lateral direction on the human-powered vehicle 10 in accordance with an output of at least one strain gauge 72. In an example, the calculator 82 calculates the load acting in a lateral direction using Expression 3. In Expression 3, the term “F3” represents load acting in a lateral direction on the front wheel 12F. In Expression 3, the term “L1” represents a distance from the load point of the load acting in a lateral direction on the front wheel 12F to the center axis C of the shaft member 60. In Expression 3, the term “F1” represents load acting in a vertical direction on the human-powered vehicle 10. In Expression 3, the term “L2” represents a distance from the first strain gauge 72A to the second strain gauge 72B.

F3=(F1×L2)/L1 Expression 3:

### Modifications

The description related to the embodiment exemplifies, without any intention to limit, applicable forms of a shaft member for a human-powered vehicle, a wheel axle for a human-powered vehicle, a hub for a human-powered vehicle, and a detection device for a human-powered vehicle according to the present disclosure. The shaft member for a human-powered vehicle, the wheel axle for a human-powered vehicle, the hub for a human-powered vehicle, and the detection device for a human-powered vehicle according to the present disclosure can be applied to, for example, modifications of the embodiment that are described below and combinations of at least two of the modifications that do not contradict each other. In the modifications described hereafter, same reference characters are given to those components that are the same as the corresponding components of the above embodiment. Such components will not be described in detail.

The setting portion 66 can include a protrusion. In a case where the setting portion 66 includes a protrusion, the protrusion can include the flat part 68.

The number of strain gauges 72 provided on one of the setting portions 66 can differ from the number of strain gauges 72 provided on another one of the setting portions 66. One or three or more strain gauges 72 can be arranged on one of the setting portions 66.

The shaft member 60 can include a member other than the hub axle 16A. The shaft member 60 can include a member other than the wheel axle 12A. In an example, in a case where the human-powered vehicle 10 includes a rear suspension including a swing arm, the shaft member 60 can include a pivot shaft of the swing arm. The shaft member 60 can include any shaft member for a human-powered vehicle that is configured to be attachable to the body 14 of the human-powered vehicle 10 in a manner restricting rotation relative to the body 14.

The detection device 80 can be configured to detect an actuation of the brake device 46 in accordance with an output of at least one strain gauge 72. In an example, the calculator 82 detects actuation of the brake device 46 based on load acting in a front-rear direction on the human-powered vehicle 10 and load acting in a vertical direction on the human-powered vehicle 10. In an example, the calculator 82 is configured to determine that the brake device 46 is actuated in a case where the load acting in a front-rear direction on the human-powered vehicle 10 and load acting in a vertical direction on the human-powered vehicle 10 are greater than or equal to a predetermined load.

The calculator 82 can be configured to determine a predetermined operation performed by a rider on the human-powered vehicle 10 in accordance with an output of at least one strain gauge 72. The predetermined operation includes, for example, at least one of a first operation of the rider pushing the handlebar 32 of the human-powered vehicle 10 and a second operation of the rider pulling the handlebar 32. At least one of the first operation and the second operation is, for example, an operation performed by the rider in accordance with irregularities of the terrain. In a case where the first strain gauge 72A and the second strain gauge 72B are arranged on a surface of the shaft member 60 facing upward and the fifth strain gauge 72E and the sixth strain gauge 72F are arranged on a surface of the shaft member 60 facing downward, the calculator 82 is configured to determine that the first operation is performed if tensile strains detected by the first strain gauge 72A and the second strain gauge 72B are increased and compression strains detected by the fifth strain gauge 72E and the sixth strain gauge 72F are increased. In a case where the first strain gauge 72A and the second strain gauge 72B are arranged on a surface of the shaft member 60 facing upward and the fifth strain gauge 72E and the sixth strain gauge 72F are arranged on a surface of the shaft member 60 facing downward, the calculator 82 is configured to determine that the second operation is performed if compression strains detected by the first strain gauge 72A and the second strain gauge 72B are increased and tensile strains detected by the fifth strain gauge 72E and the sixth strain gauge 72F are increased.

In this specification, the phrase “at least one of” as used in this disclosure means “one or more” of a desired choice. As one example, the phrase “at least one of” as used in this disclosure means “only one choice” or “both of two choices” in a case where the number of choices is two. In another example, in this specification, the phrase “at least one of” as used in this disclosure means “only one single choice” or “any combination of equal to or more than two choices” if the number of its choices is equal to or more than three.

What is claimed is:

1. A shaft member for a human-powered vehicle, the shaft member being configured to be attachable to a body of the human-powered vehicle in a manner restricting rotation relative to the body, the shaft member comprising:
a setting surface on which strain gauges are arrangeable,
the setting surface including a plurality of setting portions configured to allow for arrangement of one or more of the strain gauges, and
the setting portions are provided in the setting surface at different positions in a circumferential direction of the shaft member.

2. The shaft member according to claim 1, wherein
each of the setting portions includes a flat part.

3. The shaft member according to claim 2, wherein
each of the setting portions includes a recess.

4. The shaft member according to claim 1, wherein
at least one of the setting portions is configured to allow at least two of the strain gauges to be arranged in an axial direction of the shaft member.

5. The shaft member according to claim 1, wherein
two of the setting portions are provided at positions that differ in phase by 90 degrees in the circumferential direction of the shaft member.

6. The shaft member according to claim 1, wherein
two of the setting portions are provided at positions that differ in phase by 180 degrees in the circumferential direction of the shaft member.

7. The shaft member according to claim 6, wherein
the two of the setting portions are substantially equal in shape.

8. The shaft member according to claim 1, wherein:
the setting portions include four setting portions;
the four setting portions of the setting surface are provided parallel to a center axis of the shaft member at equal intervals in the circumferential direction of the shaft member; and
the strain gauges arranged on two of the setting portions that differ in phase by 180 degrees in the circumferential direction of the shaft member are bridge-connected to each other.

9. The shaft member according to claim 1, further comprising:
a first end and a second end in an axial direction of the shaft member, wherein
the setting surface includes at least one wire groove in which electric wires connected to the strain gauges are arrangeable, and
the at least one wire groove is located between at least one of the setting portions and at least one of the first end and the second end.

10. The shaft member according to claim 9, wherein
the at least one wire groove is located between every one of the setting portions and at least one of the first end and the second end.

11. The shaft member according to claim 9, wherein:
the first end includes a male thread used for attaching the shaft member to the body;
the at least one wire groove is located between at least one of the setting portions and the first end; and
the at least one wire groove extends through the male thread in the setting surface.

12. The shaft member according to claim 11, wherein
the first end has a larger maximum outer diameter than the second end.

13. The shaft member according to claim 1, wherein:
the body includes a frame of the human-powered vehicle; and
the shaft member is configured to be attachable to the frame.

14. The shaft member according to claim 1, wherein
the shaft member includes a wheel axle of the human-powered vehicle.

15. The shaft member according to claim 1, wherein
the shaft member includes a hub axle of the human-powered vehicle.

16. The shaft member according to claim 1, wherein:
the human-powered vehicle includes a hub;
the hub includes a hub shell; and
at least some of the setting portions are arranged in a cavity defined in the hub shell.

17. The shaft member according to claim 16, wherein:
the hub shell includes two hub flanges; and
the setting portions are configured to be arranged between the two hub flanges of the hub shell in an axial direction of the shaft member.

18. The shaft member according to claim 1, further comprising
the strain gauges arranged on the setting surface.

19. A hub for a human-powered vehicle, the hub comprising:
the shaft member according to claim 15.

20. A wheel axle for a human-powered vehicle, the wheel axle comprising:
a first end in an axial direction of the wheel axle, the first end including a male thread configured to be engaged with a female thread provided in a frame of the human-powered vehicle; and
a setting surface including at least one setting portion configured to allow for arrangement of at least one strain gauge.

21. The wheel axle according to claim 20, further comprising:
a second end opposite the first end in the axial direction of the wheel axle; and
at least one of the first end and the second end includes a tool engagement portion engageable with a tool to fasten the male thread to the female thread.

22. A detection device for a human-powered vehicle, the detection device comprising:
at least one strain gauge configured to be provided on a shaft member of the human-powered vehicle; and
a calculator that calculates load acting in a lateral direction on the human-powered vehicle in accordance with an output of the at least one strain gauge.
